(19) United States
(12) Patent Application Publication
(10) Pub. No.: US 2008/0168128 A1
(43) Pub. Date: Jul. 10, 2008

(54) SYSTEM FOR PROVIDING IMMEDIATE ASSISTANCE IN AN ELECTRONIC TRADING SYSTEM

(76) Inventor: Tobias Young, Surrey (GB)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/966,409

(22) Filed: Dec. 28, 2007

Related U.S. Application Data
(60) Provisional application No. 60/878,029, filed on Dec. 29, 2006.

(51) Int. Cl. G06F 15/16

(52) U.S. Cl. 709/202

(57) ABSTRACT

In a system and method for providing immediate assistance to a user of a computer-based system such as an asset trading system, the system provides an object such as a button for a user to select or activate while using the system. Once the object is selected, the system initiates contact between a representative of the system and the user by utilizing stored contact information provided by the user during registration.

### CROSS-REFERENCE TO RELATED APPLICATIONS

The present application claims the benefit of U.S. Provisional Application Ser. No. 60/878,029, filed Dec. 29, 2006, which is hereby incorporated by reference in its entirety.

### BACKGROUND OF THE INVENTION

Systems that allow users to buy, sell or trade financial products, commodities or other assets using a computer have become common in recent years. These systems typically allow a user to set up an account in order to buy, sell or trade assets. Many of these systems function over the Internet. Computer-based buy-side, sell-side and trading systems are convenient for users because they allow the user to research, buy, sell and trade financial products, commodities or other assets from any computer connected to a network, such as, for example, the Internet. Computer-based buy-side, sell-side and trading systems also reduce the cost associated with buying, selling or trading financial products, commodities or other assets because very little human interaction is necessary to facilitate the buying, selling and/or trading of such financial products, commodities or other assets.

Because such computer-based systems have become so easy to use, the systems have made the financial, commodities and other markets accessible for many more individuals, particularly over the Internet. While this allows users from all over the world to conveniently invest their money, it has also led to a rise in the number of investors who do not fully understand the functionality of such markets or systems that allow access to such markets.

Computer-based buy-side, sell-side and/or trading systems are also utilized by sophisticated investors. These investors typically engage in many transactions as part of their investment strategy. Sophisticated investors often have questions concerning how to engage in certain transactions on a given system, such as, for example, how to set up a limit order for a given stock. Sophisticated users sometimes find it frustrating to figure out how to set up a particular transaction on an computer-based buy-side, sell-side or trading system, particularly because time is often of the essence when the user wishes to engage in a transaction. For example, if a user sees that a particular stock is priced well below perceived value, the user will want to buy a large amount of that stock immediately before the value begins to rise. If the mechanism for executing the desired transaction is not immediately apparent, the user may lose the ability to take full advantage of the depressed price as time passes. Moreover, during peak times in the financial, commodities or other markets it is often difficult to obtain assistance in the use of such systems or completing a transaction.

Thus, there is a need for a system and method that provides immediate assistance to users of computer-based trading systems.

### BRIEF SUMMARY OF THE INVENTION

The present invention includes a system and method for providing immediate assistance to users of computer-based systems, and in particular asset trading systems. The invention preferably requires users to register or be registered with the system and obtain information about the users, such as, for example, name and telephone number, which is then stored in a database. The invention includes an object, such as, for example, an icon, screen button, menu item, keyboard button, audio command, or some other mechanism for the user to initiate contact with an agent of the system. For example, a conspicuous button may be located at a particular orientation on the screen of a computer-based trading system. The button may include a descriptor such as, for example, the words “CALL ME” written on it, but may have any other message-written on it or no message as desired. Alternatively or additionally, the button may have a design element or specific color to distinguish it from other buttons on the user's screen. The button may be activated by a user using an input device, such as, for example, by clicking on it with a mouse or touching a particular key on the user's keyboard. When the user activates the button, for example, by clicking on the button with the user's mouse, a message is sent to at least one agent of the trading system together with the user's contact information, such as, for example, the user's phone number. The agent may immediately contact the user, for example, by audio communication, such as by telephone, for example, POTS or VoIP, to discuss the user's concerns, whether they are technical or substantive in nature.

The message sent by the system to the at least one agent may be an instant message, e-mail, text message, phone call, or combination thereof. The message preferably contains the name and phone number of the customer to be contacted.

The message may include a hypertext link or other object which, if selected by the agent, will instantly connect the agent to the user. The object may dial the phone number of the user on the agent's telephone system. The object may also create an instant messaging connection or connect the agent to the user's computer such that the agent may view the user's current computer display. In one embodiment, the connection is a combination of these elements, such as an audio connection accompanied by a shared display. The agent may also be given control of the user's computer and input devices so that the agent may navigate the user through a transaction.

The message sent to the agent may also contain other information concerning the user, such as information detailing the user's asset portfolio, trade history, and recent transactions. In one embodiment, the message includes a hypertext link which, if selected by the agent, will access account information concerning the user.

The button displayed to the user may include a drop-down menu which allows the user to specify the nature of their question or concern before they select the button. The drop-down menu preferably contains categories related to the functionality of the system. The selection of the user is preferably included in the message sent to the agent or agents of the system when the user activates the button.

The button may also include a text box which allows a user to type their concern or question directly into the box. Anything the user types in will preferably be included in the message created by the system when the user activates the button.

The message created by the system when a user activates the button may be routed to a particular agent or group of agents depending on the category the user has selected from the drop-down menu, the concern that the user has typed in to the text box, the screen the user is viewing when the user selects the button, the size of the user's portfolio, or another variable. This routing allows the system to send the message to the agent best prepared to answer the user's concern.

The message sent to the agent may also include a log of all of the keystrokes and selections a user has made in the session for which the user has requested a phone call. This log of events may explain to the agent how a user has arrived at a particular point and what the user needs assistance with.

The message may also include a captured screen, such as a captured screen depicting the screen that the user was viewing at the time the user selected the button. This screen shot may instruct the agent as to what the user needs assistance with.

### BRIEF DESCRIPTION OF THE DRAWINGS

FIG. 1 depicts one possible hardware configuration for implementation of the present invention.

FIG. 2 depicts an example of a screen with a contact request button according to the present invention.

FIG. 3 depicts an another example of a screen with a contact request button according to the present invention.

FIG. 4 depicts an another example of a screen with a contact request button according to the present invention.

FIG. 5 depicts a flow diagram showing the steps of a method according to the present invention.

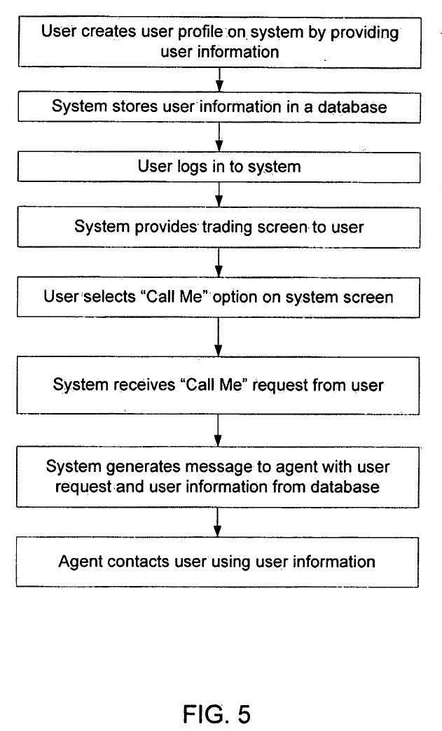

### DETAILED DESCRIPTION OF THE INVENTION

A preferred embodiment of the invention will be described with reference to an asset trading system. For purposes of this description, the term “asset trading system” refers to an electronic system adapted for buying, selling, trading, exchanging, offering and/or making markets relating to financial instruments, commodities and/or other assets, such as, for example, stocks, bonds, fixed income securities, derivatives, asset-backed securities, commodities, options, futures, foreign exchange instruments, currency, shares of REITs (real estate income trusts) or mutual funds or other types of assets or offerings. One skilled in the art will recognize that the present invention may be utilized on virtually any web site, online system, or computer-based system.

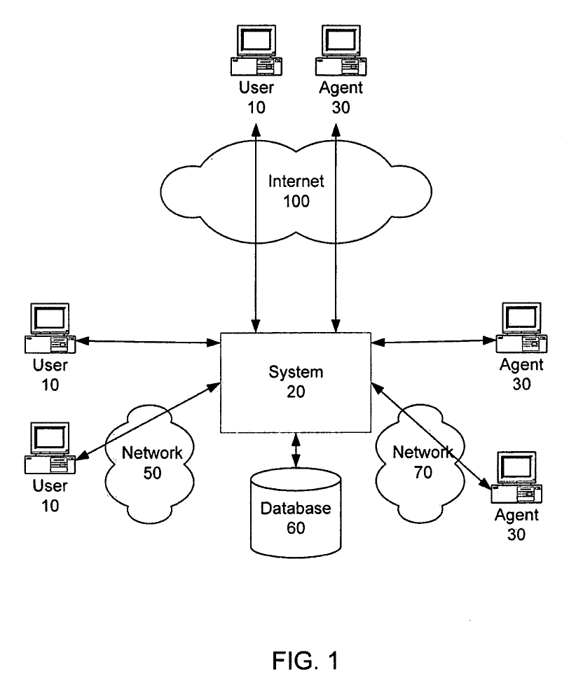

FIG. 1 depicts an example of a hardware configuration that may be used to implement the present invention. As depicted in FIG. 1, a plurality of users 10 may access the trading system 20 through the Internet 100, directly, or through a network 50 such as a local area network or wide area network. The system 20 may then contact agents working for the system in the same ways: through the Internet, directly, or through a network 70.

When a user registers with the trading system 20, the user creates a profile that is stored in a database 60 accessible by the system. The profile preferably includes information such as the user's work address and telephone number. In one embodiment, the user's home address and telephone number are also included in the profile. The user is also asked to create a username and password in order to access the system in the future.

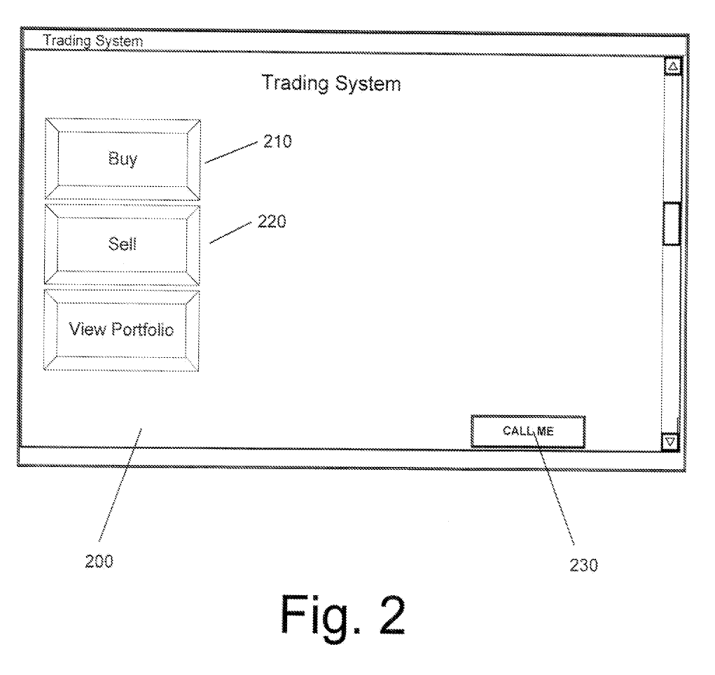

FIG. 2 depicts a sample screen of a trading system according to the present invention. The screen 200 may have buttons such as a button to buy assets 210, a button to sell assets 220, and other buttons related to the system. The screen 200 also has a “Call Me” button 230. The “Call Me” button is preferably conspicuous on the screen so that a user may locate it quickly if they need it. The button is preferably a bright color and is located in the corner of a user's screen so that the user need not search for the button. The “Call Me” button may be activated using a mouse as is typical in the Microsoft Windows environment, or using a keystroke set up by the system.

When a user logs in to the trading system with a username and password, the user's record that is stored in the system's database is accessed. If that user clicks the “Call Me” button at any time, the system sends a message to an agent of the system with the user's name and telephone number. The agent will then immediately telephone the user to assist the user with any question or concern they have.

The message sent to the agent may be instant message or an e-mail notification containing the user's name and telephone number. The message preferably instructs the agent to call the user. The system may also simply automatically initiate a phone call to both the user and to an agent of the system which will connect them instantly. In another embodiment, the system may place a phone call to an agent with a voice message containing the user's name and telephone number. Alternatively, the system may generate and send a text message to an agent with the user's name and telephone number.

In one embodiment, there may be a “Call Me” button on the login screen of the system which may be useful if a user has trouble logging in. In this embodiment, the user may click the “Call Me” button and is then prompted to enter a phone number. Once the system receives the phone number, the system will automatically send an instant message to an agent of the system with the user's phone number so that the agent may immediately phone the user.

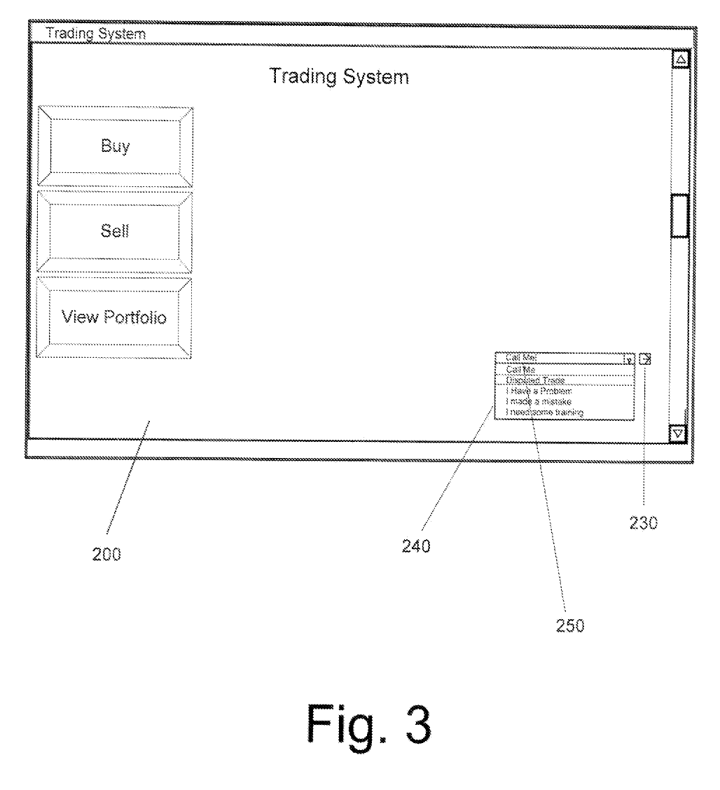

As depicted in FIG. 3, the “Call Me” button 230 may have a drop-down menu 240 associated with it as known in the art which will allow the user to select a number of options before clicking the “Call Me” button 230. When the user clicks the drop-down menu 240, a list of options will appear for the user which may allow the user to specify the nature of their inquiry or concern. In the example depicted in FIG. 3, the options include “Disputed Trade,” “I have a problem,” “I made a mistake,” and “I need some training.” Other options may be included depending on the setup of the system such as “I need help making a trade” or “How can I set a stop order?” The user may select one of the drop-down items and then click “Call Me.” The system will then generate a message to an agent of the system with the user's name, telephone number, and the nature of the user's inquiry.

In one embodiment, the system will include a text box 250 located next to the “Call Me” button 230. This text box 250 allows a user to type in the nature of their question or concern. The input received by the user will be included in the message sent to the agent of the system so that the agent knows the nature of the user's concern before the agent calls the user.

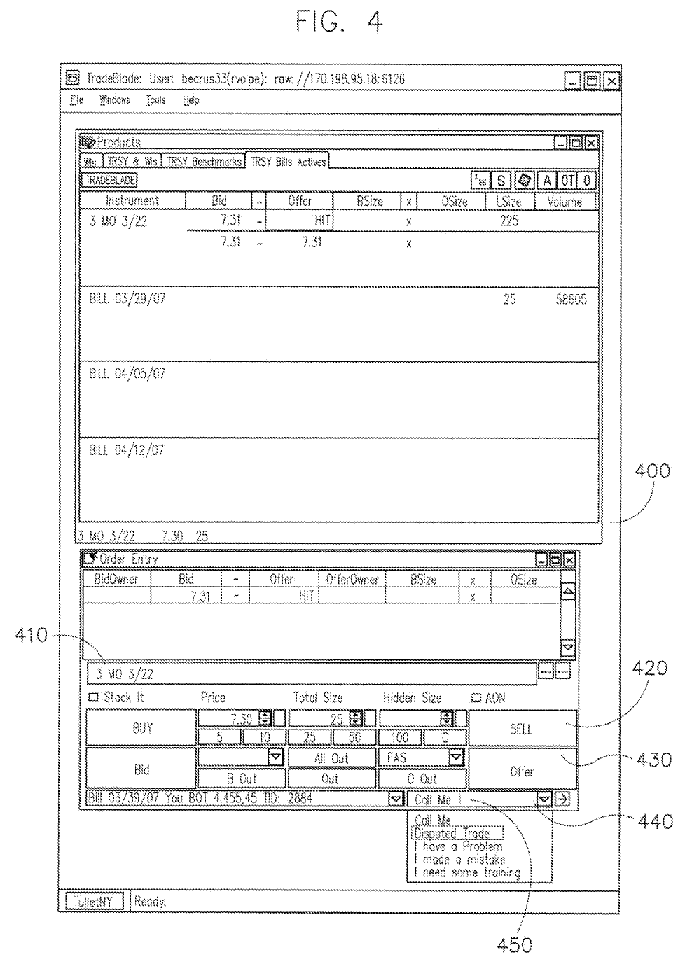

An alternate embodiment of a screen in a system according to the present invention is depicted in FIG. 4. FIG. 4 shows a screen 400 of a trading system including items typically associated with asset trading systems such as a “BUY” button 410 and a “SELL” button 420. The screen 400 also includes a “Call Me” button 430 and a drop-down menu 440 associated with the button. In this embodiment, the user may simply click the “Call Me” button 430 or they may select an item from the drop-down menu 440 before clicking the “Call Me” button 430. This embodiment also includes a text box 450 which allows the user to type in a question or concern before selecting the “Call Me” button 430.

The system may be programmed to route the request for a call to a particular agent or group of agents depending on the nature of the request. In this embodiment, the system routes the request to the agent best equipped to handle the particular request.

For example, if the user clicks the “Call Me” button while attempting to log in, the system will send a message to an agent in the customer service department who is trained to assist in the usage of the trading system. That agent will then call the user in order to provide log in assistance. In another example, if a user clicks the drop-down arrow next to the “Call Me” button on the trading screen, selects “I am interested in purchasing long-term bonds,” and clicks “Call Me” the system will generate a message or e-mail and send it to an agent of the system such as a bond trader who is able to discuss the benefits and detriments of bond purchasing with the user.

The messages sent to employees of the system may be linked to a telephone system, such as a Voice over Internet Protocol system (VoIP) so that the agent receives an e-mail or instant message with a link that allows the agent to simply click the message or the link and the system will place a telephone call between the agent and the user. In this embodiment, the agent does not have to type or dial the telephone number of the user which saves a considerable amount of time. The agent is almost immediately placed in contact with the user.

In one embodiment, the system keeps track of a list of agents that are available and only sends messages to agents that are available. In this embodiment, the messages are never placed in a queue because they are only routed to available agents who are able to place calls to the users immediately. When an agent is on a call, the agent may notify the system that they are unavailable until the call has ceased so that no further messages are sent to the agent while the agent is assisting a user.

In one embodiment, the system has software which receives requests from users when the “Call Me” button is pressed and saves a record of each request. The records may include the user's name, telephone number, and, if available, any information concerning the nature of the request. The records of the requests may be useful to track request trends and determine possible improvements to the system.

Components that can be used to construct an embodiment of the system according to the present invention is shown in U.S. Pat. Nos. 6,282,284, 5,907,547, and 6,049,602, and each is incorporated herein by reference in their entireties. U.S. Pat. No. 6,282,284 to Dezonno et al. (“Dezonno”) entitled “Method and System for Establishing Voice Communications Using a Computer Network” was issued on Aug. 28, 2001. Dezonno discloses a system for automatically establishing communications between a user and an agent. U.S. Pat. No. 5,907,547 to Foladare et al. (“Foladare I”) entitled “System and Method for Establishing Internet Communications Links” issued on May 25, 1999. Foldare discloses a software application for automated calling between an agent and a user. U.S. Pat. No. 6,049,602 to Foladare et al. (“Foladare II”) entitled “Virtual Call Center” issued on Apr. 11, 2000 and discloses a method of creating a virtual call center in a remote location.

In an alternative embodiment, the system asks users for home, work, and cellular telephone numbers when the user registers with the system. The system may then determine which number to call when a user clicks the “Call Me” button based on the time of day that the button is clicked. For example, if the button is clicked at 8 pm on a Saturday, the system will include the user's home number on any instant message or e-mail sent to employees. Conversely, if the “Call Me” button is pressed at 10 am on a Tuesday, the system may include the user's work telephone number in the message or e-mail. Alternatively, the user may specify the phone number at which they prefer to be contacted.

The system may be set up to capture the screen that the user is viewing at precise moment that the user clicks the “Call Me” button. The screen shot will then be sent with the message to the agent so that the agent may see precisely what the user was viewing when the user requested the call.

The system may also be set up to create a log file which stores all of the keystrokes and selections that a user makes from the time that user logs in up to the point that the user clicks the “Call Me” button. The log file is preferably sent with the message to the agent so that the agent may see exactly what transactions and selections the user made before the user selected the “Call Me” button. This log file may aid the agent in assisting the user.

The message sent to the agent may contain information about the user's asset portfolio and recent transactions that the user has participated in. This information may assist the agent in providing advice or assistance to the user. In another embodiment, the message may contain a link to the user's profile so that the agent may click the link and view the user's profile if desired.

It will be apparent to one skilled in the art that various modifications and variations on the invention are possible without departing from the scope of the invention as set forth in the appended claims.

What is claimed is:

1. A method for initiating contact between a user of an asset trading system and an agent of the system, the method comprising:
receiving user profile information from the user;
providing a user with access to the asset trading system;
receiving a request from the user via an object, wherein the object enables communication between the user and the agent of the system;
generating a message including the user profile information in response to the request;
transmitting the message to at least one agent of the system.

2. The method of claim 1, wherein the object is displayed on the user's computer screen.

3. The method of claim 2, wherein the object is displayed in the form of a “Call Me” button.

4. The method of claim 1, wherein the object further displays a menu of items and wherein the items are selectable by the user.

5. The method of claim 4, wherein the message includes an item selected by the user.

6. The method of claim 5, wherein the message is sent to a predetermined agent based on an item selected by the user.

7. The method of claim 1, wherein the object is expandable.

8. The method of claim 1, wherein a portion of the object is expandable.

9. The method of claim 1, wherein the object includes a drop down screen.

10. The method of claim 1, wherein the object further includes a text box which allows a user to input information into the box.

11. The method of claim 10, wherein the message includes the information.

12. The method of claim 11, wherein the message is sent to a predetermined agent based on the information.

13. The method of claim 1, wherein the information is a text string.

14. The method of claim 1, wherein the message further includes a picture of a screen displayed to the user.

15. The method of claim 14, wherein the screen included in the message is the screen displayed to the user at the time the request is received from the user.

16. The method of claim 1, wherein the message further includes information concerning a portfolio of the user.

17. The method of claim 1, wherein the message further includes a log of the user's recent transactions.

18. The method of claim 1, wherein the message further includes an object which activates an automated process that connects the agent to the user.

19. The method of claim 18, wherein selection of the object by the agent activates the automated process.

20. The method of claim 1, wherein the message is sent in the form of an e-mail.

21. The method of claim 1, wherein the message is sent in the form of a text message.

22. The method of claim 1, wherein the message is sent in the form of an instant message.

23. The method of claim 1, wherein the message is sent in the form of an audio connection.

24. The method of claim 23, wherein the audio connection is accomplished via a POTS connection.

25. The method of claim 23, wherein the audio-connection is accomplished via a VoIP connection.

26. The method of claim 18, wherein the connection is accomplished via an audio connection.

27. The method of claim 26, wherein the audio connection is accomplished via a POTS connection.

28. The method of claim 26, wherein the audio connection is accomplished via a VoIP connection.

29. The method of claim 18, wherein the connection provides the agent with access to the user's display.

30. The method of claim 29, wherein the access by the agent includes control of the user's input device.

31. The method of claim 18, wherein the connection provides the agent with access to the user's display and provides an audio connection to the user.
